(19) United States
(12) Patent Application Publication
(10) Pub. No.: US 2025/0362229 A1
(43) Pub. Date: Nov. 27, 2025

(54) HOUSEHOLD APPLIANCE WITH A SENSOR DEVICE

(71) Applicant: emz-Hanauer GmbH & Co. KGaA, Nabburg (DE)

(72) Inventors: LUKAS SCHADE, Nabburg (DE); MARTIN BRABEC, Nabburg (DE)

(21) Appl. No.: 19/185,616

(22) Filed: Apr. 22, 2025

(30) Foreign Application Priority Data
May 23, 2024 (DE) 102024114519.6

(51) Int. Cl. G01N 21/59; C02F 1/00; G01N 21/51

(52) U.S. Cl. CPC G01N 21/59; C02F 1/003; C02F 1/008; G01N 21/51; C02F 2209/003; C02F 2209/11; C02F 2307/12

(57) ABSTRACT

A water-carrying household appliance (1) includes a process compartment (2) into which a process liquid (3) can be introduced and a sensor device (4). The sensor device (4) has at least one radiation source device (5) and at least one detector device (8). The sensor device (4) in each case determines a transmission value along at least two radiation paths through the process liquid (3). The two radiation paths run spatially separated from one another at least within the process liquid (3). A turbidity value of the process liquid (3) is determined from a comparison of the at least two transmission values.

### CROSS-REFERENCE TO RELATED APPLICATIONS

This application claims priority to German Patent Application 102024114519.6, filed on May 23, 2024, the contents of which are incorporated by reference herein in their entirety.

### TECHNICAL FIELD

The invention relates to a water-carrying household appliance comprising a process compartment in which a process liquid can be introduced and a sensor device.

### BACKGROUND

A corresponding water-bearing household appliance is, for example, a dishwasher or a washing machine. The water-bearing household appliance comprises a process compartment in which the items to be cleaned are stored. A process liquid, which is usually water, is supplied to this process compartment. Additives may also be added to the process liquid. Such additives can be, for example, detergent, rinse aid or similar. During a process, for example a washing process, it is now desirable to monitor the turbidity of the process liquid. Turbidity of the process liquid is caused, for example, by dirt particles being washed out of or from the items to be washed. By monitoring a turbidity level, a washing process can be carried out automatically depending on the turbidity of the process liquid or the degree of contamination of the process liquid. Common turbidity meters determine the turbidity of the process liquid by means of a transmission value.

Mechanical circulation of the process liquid often results in air being introduced into the process liquid, causing bubbles to form in the process liquid which falsify the transmission measurement.

### SUMMARY OF THE INVENTION

The problem to be solved is to provide a water-bearing household appliance with a sensor device that can prevent or reduce falsification of the turbidity of the process liquid caused by bubbles in the process liquid in a cost-effective and reliable manner.

According to the invention, a water-carrying household appliance is provided, comprising a process compartment into which a process liquid can be introduced and a sensor device, wherein the sensor device comprises at least one radiation source device and at least one detector device, wherein the sensor device determines a transmission value along at least two radiation paths through the process liquid in each case, wherein the two radiation paths run spatially separated from one another at least within the process liquid, wherein a turbidity value of the process liquid is determined from a comparison of the at least two transmission values.

A transmission value describes the radiation permeability of a medium. Usually, an electromagnetic wave, in particular light, is sent along a radiation path from a source to a detector. The transmission value can be determined by comparing a radiation intensity emitted by the source and a transmitted intensity detected by the detector. To determine turbidity, a transmission value for a clean medium, for example clear water or air, is compared with a transmission value for a turbid medium. The lower the transmission value for a cloudy medium compared to the transmission value for a clean medium, the cloudier the cloudy medium.

In a water-bearing household appliance, for example, mechanical circulation of the process liquid, additives, cleaning agents, impurities, gases present in the process liquid, etc. cause bubbles to form. These bubbles form a phase boundary to the process liquid, whereby radiation is refracted at the transition due to the different refractive indices of the two phases. The radiation can also be scattered by the bubble. This, or the refraction in particular, means that the radiation no longer completely hits the detector device, resulting in a lower transmission value being determined than without the deflection of the radiation caused by the refraction and scattering. This in turn leads to the turbidity of the process liquid being determined as being cloudier than it actually is.

In most cases, the bubbles in the process liquid move along a flow. Such moving bubbles are usually only arranged for a short time within a radiation path, whereby these artefacts can easily be filtered out using filters, for example low-pass filters. However, so-called stationary bubbles are formed on the walls of the household appliance in particular and adhere to the wall. The stationary bubbles remain there for several seconds to minutes until they dissolve. If such a bubble forms or adheres within a radiation path, the transmission value is permanently falsified. As the bubbles have different and unpredictable lifetimes, it is not possible to filter them out using filter functions.

According to one embodiment, the determined transmission values of at least one radiation path are filtered by amplitude and/or frequency modulation. Alternatively or additionally, it would also be conceivable to filter the radiation by amplitude and/or frequency modulation.

Preferably, the at least one radiation source device can comprise a radiation source which can be selected from the following group: an LED, a laser, a superluminescent LED, a thermal radiator. The radiation generated by the radiation source device preferably has a wavelength of 400 nm to 950 nm.

The at least one detector device may contain at least one detector, preferably selected from the group comprising: a phototransistor, a photodiode, a bolometer. Combinations of the components mentioned would also be conceivable. Advantageously, the detector devices may comprise further electronic circuitry to provide a required format of the information signal. Advantageously, the detector devices only detect radiation in a wavelength range, with the range having a width of <200 nm, more preferably <100 nm. It is also conceivable that the detector devices are broadband detectors. It is conceivable that the detector devices comprise sensors or active layers arranged in series, for example detector devices with different band gaps in the active zones.

Furthermore, the detector devices could advantageously be equipped with a short-pass or long-pass filter or a band-pass filter. Similarly, the radiation source devices could be equipped with wavelength filters. However, the components mentioned could also be placed as a separate component in the respective radiation paths downstream of a radiation source device or upstream of the detector devices. The aforementioned components could also be designed as a separate component in the form of a switchable, segmented filter wheel. A filter wheel could have different segments that filter out different wavelength ranges. Alternatively, the components mentioned could be switchable glass, the transmission of which can be varied in certain wavelength ranges by applying an electrical voltage or a temperature. Such glass can be electrochromic or thermochromic. It can also be LC glass, the function of which is similar to an LC display.

Preferably, a control device is provided, which is connected to the detector devices in terms of signalling. Preferably, the control device evaluates information signals from the detector devices, whereby a degree of turbidity of the process liquid can be determined from a comparison of the transmission values. Advantageously, the detector devices are set up to convert the detected electromagnetic radiation into an electrical variable, for example a voltage or a current. Such an electrical variable can be analysed as an information signal by the control device.

Advantageously, the control device is associated with the household appliance. However, it would also be conceivable for a control device to be associated with the sensor device. Such a control device associated with the sensor device could then be connected to a control device of the household appliance in terms of signalling.

Based on the information about turbidity, the control device of the household appliance can initiate corresponding actions. For example, a washing process or the supply of a process liquid can be controlled according to the detected degree of turbidity.

According to a particularly preferred embodiment, the sensor device has two radiation source devices and two detector devices, with a radiation path running from one radiation source device to each detector device, with the radiation paths running in opposite directions.

Measurements on certain household appliances have shown that the probability of a stationary bubble being located in the radiation path of a sensor device is approximately 10%. For a single radiation path, this means that an incorrect turbidity value is sometimes determined over several minutes. This can lead to an unnecessary supply of process liquid and thus unnecessarily pollute the environment, for example through increased water and/or energy consumption. For two spatially separated radiation paths, there is only a probability of 1% that a stationary bubble is located in each of the radiation paths. This means that there is a 99% probability that at least one of the two radiation paths is free of a stationary bubble and an unadulterated transmission value can therefore be determined.

In order to avoid interference between the two radiation paths, for example in the event that radiation from one radiation path is refracted or deflected onto the detector device of the other radiation path, it is advantageous that both radiation paths run in opposite directions. Preferably, both radiation paths are arranged in parallel.

According to one embodiment, a further detector device is arranged away from the at least two radiation paths. Offside means that radiation travelling along the radiation path does not impinge on the further detector device. The further detector device can be arranged at a particular angle to one of the radiation paths. The further detector device should only detect scattered radiation. The size, position and lifetime of the bubbles can be deduced from the detected scattered radiation.

According to a particularly preferred embodiment, a radiation source device and a detector device are each arranged on one side of a circuit board that is populated on both sides.

Advantageously, the radiation source devices and detector devices can be arranged on a circuit board fitted on both sides; the circuit board therefore also acts as a diaphragm and separates the two radiation paths from each other. In addition, the radiation source devices and detector devices that are not connected by a common radiation path can thus be easily separated from each other in order to prevent unwanted irradiation. Another advantage is the smaller interspace requirement compared to a circuit board equipped on one side.

According to a particularly preferred embodiment, the circuit board, which is fitted on both sides, is U-shaped with two legs, with a detector device and a radiation source device being arranged on one of the two legs in each case, with the two radiation paths running between the two legs.

The U-shape allows the process liquid to be introduced between the two legs, whereby the process liquid can flow unhindered between the two legs. As turbidity is caused by suspended matter in particular, a lack of circulation results in an inhomogeneous spatial distribution of turbidity in the process compartment of the household appliance. A lack of circulation mainly occurs behind or in front of barriers such as walls. A sensor device shaped as a cuboid would also be such a barrier. Due to the U-shape of the circuit board and preferably also of the sensor device, the flow of the process liquid between the legs and thus through the radiation paths can take place largely unhindered, in particular completely unhindered. Preferably, the sensor device has cylindrical U-shaped legs.

According to a particularly preferred embodiment, the two transmission values are determined using radiation of different wavelengths. Furthermore, each detector device assigned to a radiation path can be designed to detect backscattering, whereby the detected backscattering occurs along the other radiation path running in the opposite direction within the process liquid.

In order to be able to reduce the mutual interference of the at least two radiation paths, the at least two transmission values are preferably determined with specific wavelengths or wavelength ranges that are different from each other. The detector devices are adapted to the specific wavelengths or wavelength ranges of their own radiation paths. Advantageously, they only detect the wavelength or wavelength range of their own radiation path. It is also advantageous that the detector devices can detect the backscatter of the radiation path travelling in the opposite direction. For this purpose, the detector device can comprise a detector that can detect both the wavelength or the wavelength range of its own radiation path and that of the opposite radiation path. Alternatively or additionally, the detector device can comprise a detector that only detects the wavelength or the wavelength range of its own radiation path and a further detector that detects the wavelength or the wavelength range of the opposite radiation path.

The detection of backscattering is advantageous, as Rayleigh scattering, for example, can be used to draw conclusions about particles present in the process liquid. Rayleigh scattering refers to the elastic scattering of electromagnetic waves by particles whose size is small compared to the wavelength of the radiation. Based on the wavelength of the backscattered radiation, it is therefore possible to draw conclusions about the particle size and thus sometimes about the particles.

According to a particularly preferred embodiment, radiation of different wavelengths is used to determine at least one transmission value along a radiation path.

Advantageously, radiation of different wavelengths is used to determine all transmission values. As the refractive index and the transmission or absorption are wavelength-dependent, precise conclusions can be drawn about the components of the process liquid by comparing the transmitted or absorbed wavelengths. It is also conceivable that the presence of a bubble in the radiation path can be determined from the different transmission of the different wavelengths.

According to a particularly preferred embodiment, at least one polarisation element is arranged in at least one radiation path.

The polarisation of an electromagnetic wave has a major influence on its behaviour. For example, in a birefringent crystal, radiation is split into two different, spatially separated beams based on the direction of polarisation, as the refractive index of the crystals is polarisation-dependent. Refraction or reflection is also sometimes dependent on polarisation. Preferably, the polarisation element comprises one of the following: a polarisation filter, a birefringent crystal or an LCD display. It is particularly preferable that the orientation of the polarisation filter can be changed so that radiation with different polarisations can pass through the polarisation element one after the other. The polarisation element is also preferably arranged between the radiation source device and the process liquid. Alternatively or additionally, the polarisation element can also be arranged between the process liquid and the detector device.

Furthermore, various optical elements such as lenses, apertures and filters can be arranged in the radiation paths between the radiation source device and the process liquid and between the detector device and the process liquid. Alternatively or additionally, a shutter can be arranged in at least one radiation path, which blocks the radiation path at least temporarily and/or regularly, whereby when the radiation path is blocked, the radiation is at least partially, preferably completely, absorbed by the shutter and/or reflected against the direction of the radiation path.

Preferably, all optical elements are arranged in one or all of the radiation paths.

According to a particularly preferred embodiment, a specific current or voltage value is assigned to the determined turbidity value of the process liquid by the sensor device, whereby the sensor device only outputs the current or voltage value corresponding to the turbidity value via only one contact.

Advantageously, the turbidity values are compared with each other within the sensor device and a single turbidity value of the process liquid is determined from this. A turbidity value is usually determined from a transmission value. This is done either by the sensor device itself or by a control device connected to the sensor device.

According to one embodiment, the sensor device outputs information about the process liquid via only one or two contacts. The information can be one of the transmission values or a turbidity value, which is determined on the basis of the transmission values.

According to a further embodiment, each transmission value is output by the sensor device via one or two contacts, with the turbidity value being determined by comparing the transmission values by a control device of the household appliance.

According to a particularly preferred embodiment, the sensor device has a housing that separates the at least one radiation source device and/or the at least one detector device from the process liquid. Furthermore, the housing has at least two optical windows, preferably two for each radiation path, with the radiation entering the housing through the optical windows and leaving the housing through the optical windows.

Advantageously, the electronic components of the sensor device are separated from the process liquid, in particular separated in a watertight manner. According to one embodiment, the radiation path passes through the housing, whereby the housing is almost transparent for the wavelengths of the individual radiation paths.

According to a particularly preferred embodiment, at least one waveguide is provided, wherein at least one of the radiation paths comprises at least one section passing through a waveguide.

Preferably, each of the radiation paths comprises at least one waveguide through which the radiation to enter the process liquid passes. Preferably, the radiation from the radiation source devices is coupled into a waveguide. After exiting the waveguide, the radiation reaches an entry point of the process liquid. Preferably, each of the radiation paths comprises at least one waveguide through which the radiation emerging from the process liquid passes towards a detector device. Advantageously, the radiation emerging from the exit point of the process liquid is coupled into a waveguide. The radiation then travels through this to a detector device.

According to a particularly preferred embodiment, when comparing the transmission values, the turbidity value determined is the mean value or the highest transmission value from all the transmission values determined.

Advantageously, the at least partial presence of bubbles in the radiation path reduces the transmission values or increases a corresponding turbidity value. As a result, it can be assumed that the transmission value is higher or the corresponding turbidity value is lower if there are no bubbles in the radiation path. The highest transmission value can therefore correspond to an actual turbidity of the process liquid. Alternatively, the mean value can also be formed from the transmission values in order to determine the actual turbidity of the process liquid.

According to a particularly preferred embodiment, a filtering process of the process liquid is initiated based on the determined turbidity value.

According to a further embodiment, fewer radiation sources can be provided as detectors. According to a further embodiment, fewer detectors than radiation sources can be provided, in which case a time-shifted measurement can take place along the at least two radiation paths. Alternatively, a beam splitter can be provided to divide a radiation path into two spatially separated radiation paths.

According to a further embodiment, at least two radiation paths are arranged in parallel and in the same direction. Advantageously, a detector device can detect at least one radiation that has been refracted by another radiation path into the radiation path associated with the detector device. If the radiation passes through the process liquid along at least one radiation path, the radiation can be refracted and/or scattered by bubbles in another radiation path. A detector device assigned to the further radiation path can detect the refracted and/or scattered radiation from at least one radiation path. Advantageously, the further radiation path or the detector device assigned to the further radiation path is not irradiated. Alternatively, the radiations can be distinguished along the at least two radiation paths, whereby the detector device assigned to the further radiation path outputs different signals for scattered and/or refracted radiation from the at least one radiation path and radiation from the further radiation path, whereby an intensity and/or an impact location of the radiation on the detector device can be determined using the signals. For this purpose, radiation with a different wavelength or radiation of a different wavelength range can propagate along the further radiation path than along the at least one radiation path, whereby the detector device distinguishes the radiation originally associated with the radiation paths, i.e. before refraction or scattering, on the basis of the different wavelengths. The size and/or number of bubbles in the process liquid can be analysed on the basis of the radiation scattered and/or refracted in the other radiation path.

For example, an overdosage of additives such as rinsing agents, detergents or cleaning agents can lead to increased bubble formation, which can result in liquid escaping from the household appliance. Advantageously, a household appliance according to the invention can detect increased bubble formation and react accordingly. Examples of such a reaction would be draining the process liquid, reducing the concentration of rinsing, washing or cleaning agent in the process liquid and pausing or terminating the rinsing, washing or cleaning process.

According to a particularly preferred embodiment, the at least two radiation paths or all radiation paths have a different length.

### BRIEF DESCRIPTION OF THE DRAWINGS

Further advantages, objectives and features of the present invention are explained with reference to the following descriptions of the attached figures. Similar components can have the same reference signs in the various embodiments.

It shows:

FIG. 1 illustrates an overall view of a household appliance according to the invention in one embodiment;

FIG. 2 illustrates a sensor device from the state of the art;

FIG. 3 is a graph illustrating measured values of the turbidity of the process liquid as a function of time;

FIG. 4 illustrates a sensor device of a household appliance according to the invention;

FIG. 5a is a graph illustrating a simulation of measured values of the turbidity of the process liquid as a function of time;

FIG. 5b is a graph illustrating a simulation of measured values of the turbidity of the process liquid as a function of time for a household appliance according to the invention;

FIG. 6 illustrates a sensor device of a household appliance according to the invention according to a further embodiment;

FIG. 7a is a front view of a sensor device of a household appliance according to a further embodiment of the invention;

FIG. 7b illustrates a sensor device of a household appliance according to the invention according to a further embodiment in a view from below and

FIG. 8 illustrates a sensor device of a household appliance according to the invention with fewer detector devices than radiation source devices.

### DETAILED DESCRIPTION

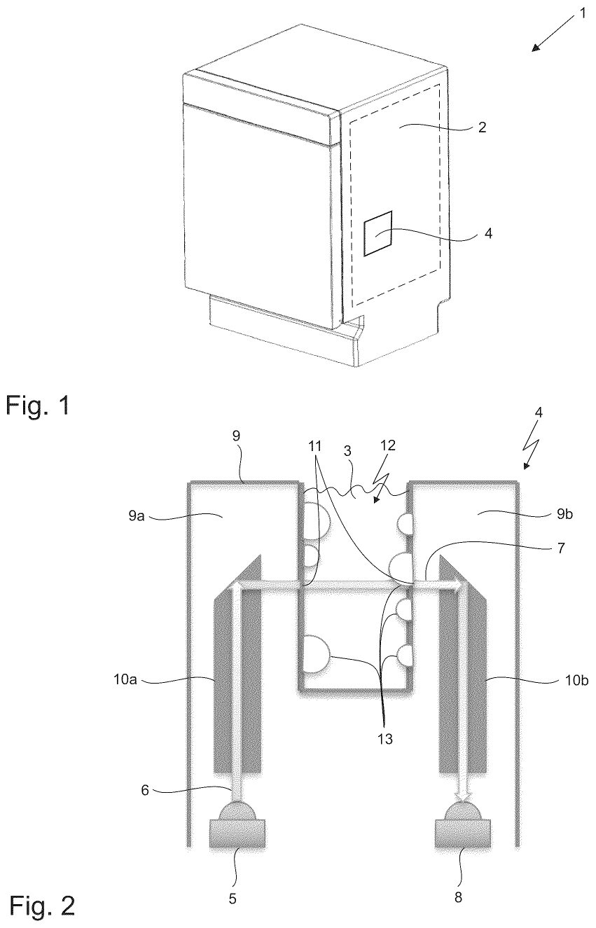

FIG. 1 shows a water-bearing household appliance 1 comprising a process compartment 2 in which a process liquid 3 can be introduced and a sensor device 4, wherein the sensor device 4 is intended and set up to detect turbidity of the process liquid 3, wherein the sensor device 4 comprises at least two radiation source devices 5, the emitted radiations 6 of which pass through the process liquid 3 via at least two spatially separated radiation paths 7a, 7b, wherein at least two detector devices 8 detect the emitted radiations 6 of the radiation source devices 5. The household appliance 1 may, for example, be designed as a dishwasher, a washing machine or the like. The sensor device 4 is integrated in the household appliance 1. It is preferable for the sensor device 4 to be at least partially is in contact with the process liquid 3.

FIG. 2 shows a sensor device from the prior art. The sensor device 4 has a radiation source device 5 with a radiation source device 5 and a detector device 8 with a detector 8. The radiation 6 generated by the radiation source device 5 is guided into a feed waveguide 10a in a first housing leg 9a of a U-shaped housing 9. There, the radiation is totally reflected at one edge of the feed waveguide so that the radiation path 7 changes its direction by 90°. The radiation 6 then leaves the feed waveguide 10a and then the housing 9 through an optical window 11. The radiation path now passes through the interspace 12 of the U-shaped housing 9 enclosed by the two housing legs 9a and 9b, which is filled with a process liquid 3 in the form of washing water 3. Within the washing water 3 are several bubbles 13, which refract the radiation 6 away from its actual radiation path 7. Inside the washing water 3 there are also particles that absorb the radiation 6. After passing through the washing water 3, the radiation 6 enters through an optical window 11 into a second leg 9b of the housing 9 and finally into a discharge waveguide 10b. In this waveguide, the radiation 6 is again totally reflected at one edge of the discharge waveguide 10b, whereupon the radiation path 7 is deflected by 90°. Inside the waveguide 10b, the radiation 6 is guided along the housing leg 9b onto the detector device 8. The detector device 8 determines a transmission value based on the intensity of the radiation transmitted along the radiation path 7. By comparing a transmission value of a clear process liquid 3 with the transmission value of a turbid process liquid 3, the turbidity of the process liquid 3 can be determined. The bubbles 13 in the liquid, especially those that adhere stationary to the housing 9, make the washing water 3 appear more turbid than it actually is due to the attenuation of the intensity caused by refraction and scattering of the radiation.

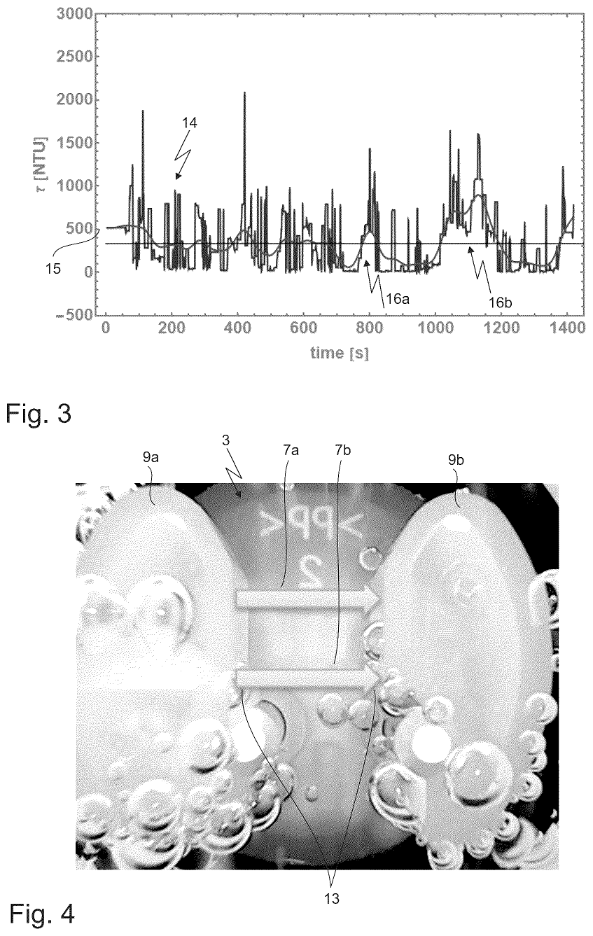

FIG. 3 shows turbidity values that have been determined on the basis of transmission values. The turbidity is shown in units of nephelometric turbidity as a function of time in seconds. The light grey line 14 shows the individual measured values, with the dark grey line 15 forming a fit. The effects of a stationary bubble 13 on the transmission value can be seen in particular at points 16a and 16b. For example, the turbidity at 16a initially increases for approx. 50 seconds before falling back to the original value for approx. 50 seconds. The same can be observed for 16b, although the stationary bubble lasts much longer, around 200 seconds. It can also be seen from line 14 that the measurement interval between the determination of the transmission values is much smaller than the lifetime of the stationary bubbles 13, with one measurement interval being less than 5 seconds.

FIG. 4 shows a sensor device 4 according to the invention. The first housing leg 9a can be seen on the left-hand side. Two spatially separated radiation paths 7, a first radiation path 7a and a second radiation path 7b, run from the housing leg 9a through the washing water 3 to the second housing leg 9b, which can be seen in the right-hand part of the figure. The radiation source devices 5 and the detector devices of the individual radiation paths can be arranged directly in the two housing legs 9a and 9b or, as shown in FIG. 2, in a connecting part between the two housing legs 9a and 9b. While the radiation 6 can pass through the washing water 3 along the radiation path 7a without encountering bubbles 13, bubbles 13 are arranged in the radiation path 7b, which reduce the transmission value determined.

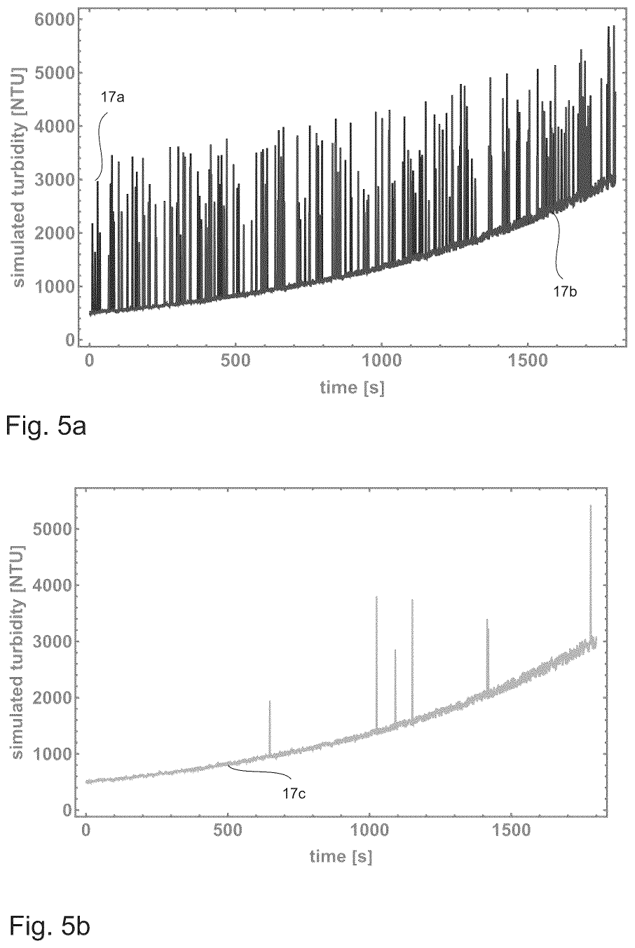

FIG. 5a shows a simulated turbidity in units of nephelometric turbidity as a function of time in seconds. The turbidity values 17a corresponding to the transmission values for the radiation path 7a and the turbidity values 17b corresponding to the transmission values for the radiation path 7b are shown. It can be clearly seen that both turbidity values regularly show turbidity values that are many times higher, than the average would suggest. Over time, it can also be seen that the washing water 3 becomes increasingly turbid.

FIG. 5b shows only the minimum 17c from the two turbidity values 17a and 17b for a measurement interval as a function of time. It is clearly recognisable that the turbidity is much more uniform and, with a few exceptions in which a bubble is arranged in both the first radiation path 7a and the second radiation path 7b, hardly any false, i.e. greatly increased, turbidity values can be seen. The minimum of the two turbidity values 17a and 17b corresponds to the maximum of the two transmission values.

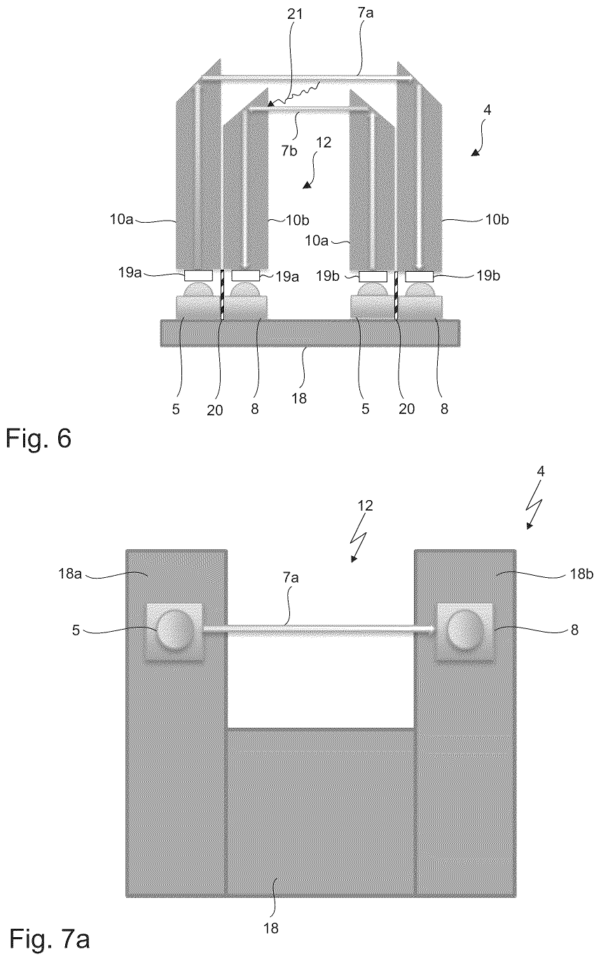

FIG. 6 shows a sensor device 4 according to the invention. Some components have been omitted for the sake of clarity. The radiation source devices 5 and detector devices 8 are arranged on a circuit board 18. The two radiation paths 7a and 7b are arranged in opposite directions. The radiation path 7a runs from left to right and the radiation path 7b runs from right to left. The radiation 6 of both radiation paths is almost monochromatic, with radiation 6 with a wavelength of around 850 nm being used for the radiation path 7a and radiation 6 with a wavelength of around 950 nm being used for the second radiation path 7b. By arranging optical elements 19a in the radiation paths between the radiation source devices 5 and the interspace or between the interspace and the detector devices 8, the polarisation or the wavelength of the radiation can be changed, for example. Filters 19b can also be arranged in the same way as the optical elements, for example to filter out certain wavelengths or polarisations. Due to the opposite direction of the two radiation paths 7a and 7b, the radiation source device 5 or the detector device 8 of the radiation path 7a or 7b is arranged adjacent to the detector device 8 or the radiation source device 5 of the radiation path 7b or 7a. The radiation source devices or detector devices 8 are arranged in such a way that they are not influenced by a neighbouring radiation source device 5 or detector device 8. For this purpose, a diaphragm 20 is arranged between radiation source device 5 and detector device 8, which shields radiation 6 from the neighbouring radiation source device.

In the event of backscattering in the radiation path 7a or 7b, the backscattered radiation 21 can be picked up by the discharge waveguide 10b of the respective other radiation path and guided to the respective detector device 8. This is designed to detect radiation 6 of both wavelengths separately. The determined backscattering allows conclusions to be drawn about the particle size and thus the components of the washing water 3.

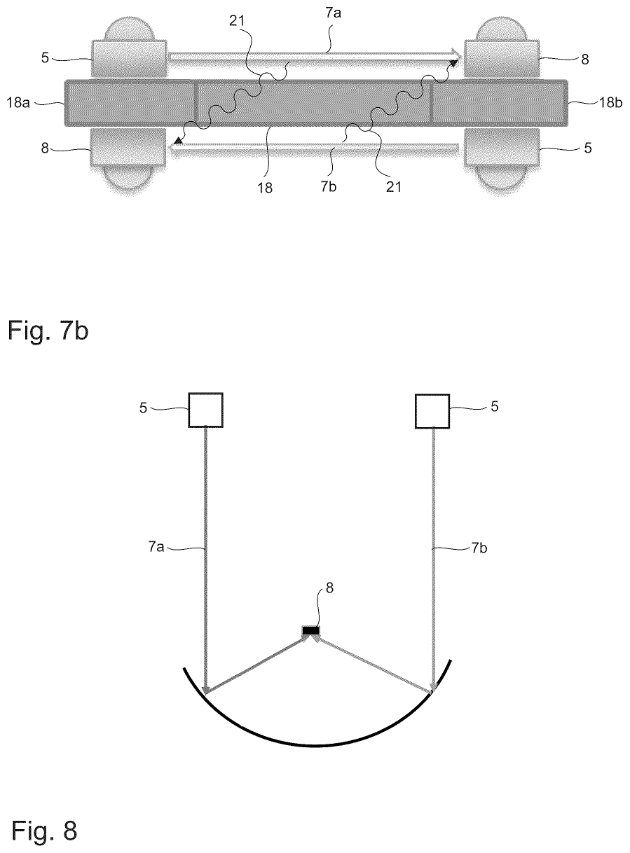

FIG. 7a shows a front view and FIG. 7b a bottom view of a further embodiment. The radiation source device 5 and detector devices 8 are arranged on a circuit board fitted on both sides. The circuit board 18 is U-shaped and the radiation source devices 5 and detector devices 8 are arranged on the legs of the circuit board 18a and 18b. This arrangement makes it possible to dispense with the use of waveguides 10a and 10b. In addition, only the radiation path 7a can be seen in FIG. 7a, as the radiation path 7b runs behind it. FIG. 7b shows a lower view of the embodiment shown in FIG. 7a. The two radiation paths 7a and 7b each run along one side of the circuit board 18, which is fitted on both sides. In this case, the radiation source devices 5 and detector devices 8 are broadband emitters and broadband detectors respectively. Along the radiation paths, radiation 21 is backscattered from the radiation path 7a into the radiation path 7b and vice versa. In this case, the radiation source devices of the individual radiation paths emit with a time delay so that it is possible to distinguish between backscattered radiation 21 and transmitted radiation.

In each case, a measurement along the first radiation path 7a and a measurement along the radiation path 7b are combined in order to be able to compare the two transmission values of the radiation paths 7a and 7b.

FIG. 8 shows an embodiment with a radiation guiding element 22, which is intended and designed to deflect radiation 6 in such a way that it is focussed on a single point or close to a point. This radiation guiding element 22 is, for example, a parabolic element or has a curved surface. For example, the curved surface may be spherical, parabolic, sinusoidal or otherwise curved. Two radiation source devices 5 are arranged relative to the radiation guiding element 22 in such a way that their radiation 6 is focussed along the two radiation paths 7a and 7b to a point, for example a detector device 8. Such a radiation guiding element 22 as a curved surface can, for example, be integrated into an optical fibre 10. The radiation paths of 7a and 7b run spatially separated from each other at least through the process liquid.

According to a further preferred embodiment, the positions of detector device 8 and radiation source device 5 can also be arranged reversed with respect to FIG. 8. In this case, the direction of the radiation paths 7a and 7b is reversed. The radiation source device then generates radiation which strikes the radiation guide element 22 and is directed from there to the two detector devices. The radiation paths of 7a and 7b are spatially separated from each other, at least by the process liquid. Alternatively or in addition to the radiation guide element 22, a radiation splitter can be arranged, which splits radiation 6 starting from a radiation source device 5 into two spatially separated radiation paths.

Each of the embodiments shown above can also comprise a microcontroller or a logic circuit, which can compare at least two transmission values and either add them up or select the largest value. Alternatively, the transmission values can also be combined with each other as desired. The sum, the maximum or the arbitrary combination is then output at a contact point of the sensor device, from where it can be forwarded to a control device. A turbidity value can then be determined from the sum, the maximum or any combination of the transmission values, which is representative of the turbidity of the process liquid 3. Alternatively or additionally, a passive comparison can also be carried out, for example by a comparator, whereby in a comparison between at least two transmission values of the at least two radiation paths, the highest of the transmission values is output as a signal.

### LIST OF REFERENCE SYMBOLS

1 Household appliance
2 Process compartment
3 Process liquid
4 Sensor device
5 Radiation source device
6 Radiation
7 Radiation path
7a First radiation path
7b Second radiation path
8 Detector device
9 Housing
9a First housing leg
9b Second housing leg
10 Waveguide
10a Feeder waveguide
10b Discharge waveguide
11 Optical window
12 Interspace
13 Bubble
14 Measured values
15 Fit of the measured values
16a Position of a stationary bubble
16b Position of another stationary bubble
17a Turbidity values according to the first radiation path
17b Turbidity values according to the second radiation path
17c Minimum of the turbidity values from the turbidity values of the first and second radiation path
18 Circuit board
18a First leg of the circuit board
18b Second leg of the circuit board
19a Optical element
19b Filter element
20 Aperture element
21 Backscattered radiation
22 Radiation guide element

1. Water-carrying household appliance (1) comprising:
a process compartment (2) into which a process liquid (3) can be introduced and
a sensor device (4), wherein the sensor device (4) comprises at least a radiation source device (5) and at least a detector device (8), wherein the sensor device (4) in each case determines a transmission value along at least two radiation paths (7a, 7b) through the process liquid (3), wherein the two radiation paths (7a, 7b) run spatially separated from one another at least within the process liquid (3), wherein a turbidity value of the process liquid (3) is determined from a comparison of the at least two transmission values.

2. Water-carrying household appliance (1) according to claim 1, wherein the sensor device (4) has two radiation source devices (5) and two detector devices (8), a radiation path running from one radiation source device (5) to each detector device (8), the radiation paths (7a, 7b) running in opposite directions.

3. Water-carrying household appliance (1) according to claim 2 further comprising a radiation source device (5) and a detector device (8) each arranged on one side of a circuit board (18) fitted on both sides.

4. Water-carrying household appliance (1) according to claim 3, wherein the circuit board (18), which is fitted on both sides, is U-shaped with two legs (18a , 18b), a detector device (8) and a radiation source device (5) being arranged on one of the two legs (18a , 18b) in each case, the two radiation paths (7a, 7b) running between the two legs (18a , 18b).

5. Water-carrying household appliance (1) according to claim 4, wherein the two transmission values are determined with radiation of different wavelengths, each detector device (8) assigned to a radiation path being designed to detect a backscattering, the detected backscattering occurring along the other radiation path running in the opposite direction within the process liquid (3).

6. Water-carrying household appliance (1) according to claim 1, wherein radiation of different wavelengths is used to determine at least one transmission value along one radiation path.

7. Water-carrying household appliance (1) according to claim 1 further comprising at least one polarisation element is arranged in at least one radiation path.

8. Water-carrying household appliance (1) according to claim 1, wherein a specific current or voltage value is assigned to the specific turbidity value of the process liquid (3) by the sensor device (4), wherein the sensor device (4) outputs the current or voltage value corresponding to the turbidity value only via one contact.

9. Water-carrying household appliance (1) according to claim 1, wherein the sensor device (4) has a housing that separates the at least one radiation source device (5) and/or the at least one detector device (8) from the process liquid (3).

10. Water-carrying household appliance (1) according to claim 1, wherein at least one waveguide is provided, wherein at least one of the radiation paths (7a, 7b) has at least one section which extends through a waveguide (10).

11. Water-carrying household appliance (1) according to claim 1, wherein when comparing the transmission values, the turbidity value is the mean value or the highest transmission value from all transmission values.

12. Water-carrying household appliance (1) according to claim 1, wherein a filtering process of the process liquid (3) is initiated on the basis of the determined turbidity value.

13. Water-carrying household appliance (1) according to claim 1, wherein the at least two radiation paths (7a, 7b) or all radiation paths have a different length.

14. Water-carrying household appliance (1) comprising:
a process compartment (2) into which a process liquid (3) can be introduced; and
a sensor device (4) comprising at least one radiation source device (5) and at least one detector device (8), the sensor device (4) being configured to determine a transmission value along at least two radiation paths (7a, 7b) through the process liquid (3), wherein the two radiation paths (7a, 7b) run spatially separated from one another at least within the process liquid (3), wherein a turbidity value of the process liquid (3) is determined from a comparison of the at least two transmission values.
